(19) United States
(12) Patent Application Publication
(10) Pub. No.: US 2025/0073785 A1
(43) Pub. Date: Mar. 6, 2025

(54) TWO-WAY INDEXABLE V-SHAPED CUTTING INSERT AND TOOL HOLDER THEREOF

(71) Applicant: ISCAR, LTD., TEFEN (IL)

(72) Inventor: GIL HECHT, NAHARIYA (IL)

(73) Assignee: ISCAR, LTD., TEFEN (IL)

(21) Appl. No.: 18/459,208

(22) Filed: Aug. 31, 2023

(51) Int. Cl. B23B 29/04

(52) U.S. Cl. CPC B23B 29/043; B23B 2200/0423; B23B 2200/081; B23B 2200/286; B23B 2200/3627; B23B 2220/12

(57) ABSTRACT

A two-way indexable V-shaped cutting insert having first and second rake surfaces located in a front insert surface thereof. First and second relief surfaces respectively connect the first and second rake surfaces to first and second converging insert abutment surfaces, respectively. A first cutting edge is located at an intersection of the first rake surface and the first relief surface. A second cutting edge is located at an intersection of the second rake surface and the second relief surface. A first relief angle is formed between the first relief surface and the first converging insert abutment surface. A second relief angle is formed between the second relief surface and the second converging insert abutment surface. The first and second relief angles are obtuse. In a cutting tool, the two-way indexable V-shaped cutting insert is releasably secured in a tool holder by means of a fastening member.

### FIELD OF THE INVENTION

The subject matter of the present application relates to the field of turning machining operations. Specifically, it relates to the field of threading, grooving and parting machining operations.

### BACKGROUND OF THE INVENTION

In the field of turning machining operations, specifically in metal machining, it is known to provide a two-way indexable V-shaped cutting insert. For example, such a cutting insert is shown in EP3702074 and JP6937987.

Specifically, EP3702074 relates to an indexable cutting insert for a cutting tool. The cutting insert comprises: a first side surface and an opposing second side surface, and a peripheral surface extending between the first side surface and the second side surface. The cutting portion comprises a first cutting face and an opposing second cutting face, a flank face extending between the first cutting face and the second cutting face, a first cutting edge between the first cutting face and the flank face, and a second cutting edge between the second cutting face and the flank face. The cutting portion is bisected by a first plane transverse to the first side surface and the cutting portion has a biconcave cross-section transverse to the first plane. The first and second cutting faces are shown having first and second rake surfaces, respectively. Accordingly, the flank face is shown with relief surfaces.

JP6937987 relates to a double-sided V-shaped cutting insert, comprises an insert front surface, an insert back surface and a peripheral surface extending between the insert front and back surfaces. The peripheral surface further comprises a forward surface, a first converging surface, which is a planar surface, and a first rake surface extending between the forward surface and the first converging surface. The peripheral surface further comprises a second converging surface, which is a planar surface, and forms a convergence angle f with the first converging surface, fulfilling the condition: 30 degrees less than or equal to f less than or equal to 45 degrees. A second rake surface extends between the forward surface and the second converging surface. A bisector plane of the convergence angle is defined between, and equally distanced from, each of the first rake surface and the second rake surface, and the cutting insert exhibits mirror symmetry about the bisector plane, at least in a view taken perpendicular to the insert front surface. The first rake surface and the second rake surface each face away from the bisector plane. The first rake surface tends towards the bisector plane more than the first converging surface, and the second rake surface tends towards the bisector plane more than the second converging surface.

It is an object of the present invention to provide a two-way indexable V-shaped cutting insert with an advantageous geometry as detailed below.

### SUMMARY OF THE INVENTION

In accordance with a first aspect of the subject matter of the present application there is provided a two-way indexable V-shaped cutting insert comprising:
a first insert side surface and a second insert side surface located opposite the first insert side surface; and
a peripheral insert surface connecting the first and second insert side surfaces; the peripheral insert surface comprising:
a front insert surface located in an insert cutting portion;
a back insert surface located opposite the front insert surface and located in an insert abutment portion, the insert abutment portion being adjacent to the insert cutting portion; and
first and second converging insert abutment surfaces converging towards one another in a direction away from the front insert surface and towards the back insert surface;
   wherein:
the front insert surface comprises first and second rake surfaces; and
the peripheral insert surface further comprises:
   a first relief surface connecting the first rake surface and the first converging insert abutment surface;
   a second relief surface connecting the second rake surface and the second converging insert abutment surface; and
      a first cutting edge and a second cutting edge, the first cutting edge located at the intersection of the first rake surface and the first relief surface, the second cutting edge located at the intersection of the second rake surface and the second relief surface.

In accordance with a second aspect of the subject matter of the present application there is provided a cutting tool comprising:
a two-way indexable V-shaped cutting insert described above;
a fastening member; and
a tool holder having a longitudinal axis defining opposing forward and rearward directions, the tool holder comprising:
   a shank portion and a holder cutting portion located in the forward direction from the shank portion;
   opposing top and bottom holder surfaces extending along, and on opposite sides of, the longitudinal axis;
   opposing front and back holder surfaces extending along, and on opposite sides of, the longitudinal axis and connecting the top and bottom holder surfaces; and
   a forward holder surface located between the top, bottom, front and back surfaces and delimiting the tool holder in the forward direction;
the holder cutting portion comprising:
an insert seat opening out to the front and forward holder surfaces, the insert seat comprising:
   a first converging holder abutment surface;
   a second converging holder abutment surface located forwardly of the first converging holder abutment surface; and
   a main holder abutment surface connecting the first and second converging holder abutment surfaces.

It is understood that the above-said is a summary, and that features described hereinafter may be applicable in any combination to the subject matter of the present application, for example, any of the following features may be applicable to the two-way indexable V-shaped cutting insert and/or the cutting tool.

A first relief angle ar1, formed between the first relief surface and the first converging insert abutment surface, and a second relief angle ar2, formed between the second relief surface and the second converging insert abutment surface, may fulfil the following condition: 90°<ar1, ar2<175°.

The two-way indexable V-shaped cutting insert may comprise exactly two cutting edges constituted by the first and second cutting edges.

The first and second converging insert abutment surfaces may be planar.

A symmetry plane may pass through the first and second insert side surfaces and bisect the two-way indexable V-shaped cutting insert. The first cutting edge may exhibit mirror symmetry relative to the second cutting edge about the symmetry plane.

The first converging insert abutment surface may exhibit mirror symmetry relative to the second converging insert abutment surface about the symmetry plane.

The two-way indexable V-shaped cutting insert may exhibit mirror symmetry about the symmetry plane.

An insert wedge angle awi may be formed between the first converging insert abutment surface and the second converging insert abutment surface. The insert wedge angle awi may fulfil the following condition: 25°≤awi≤80°.

The first and second relief angles ar1, ar2 may fulfil the following condition: 120°≤ar1, ar2≤165°.

The front insert surface may further comprise a chip deflection protrusion, the chip deflection protrusion being located between the first and second rake surfaces and farther from the back insert surface than at least a portion of the first and second rake surfaces.

The first insert side surface may comprise a first insert abutment sub-surface located in the insert abutment portion and a first cutting sub-surface located in the insert cutting portion. The second insert side surface may comprise a second insert abutment sub-surface located in the insert abutment portion and a second cutting sub-surface located in the insert cutting portion. An abutment portion thickness Ta, defined from the first insert abutment sub-surface to the second insert abutment sub-surface, and a cutting portion thickness Tp, defined from the first cutting sub-surface to the second cutting sub-surface, may fulfil the following condition: Ta>Tp.

The first cutting sub-surface may comprise a first center region and a first internal region located closer to the first and second cutting edges than the first center region. The second cutting sub-surface may comprise a second center region and a second internal region located closer to the first and second cutting edges than the second center region. A center region thickness Tc, defined as the distance from the first center region to the second center region, and an internal region thickness Ti, defined as the distance from the first internal region to the second internal region, may fulfil the following condition: Ti≤Tc.

The center region thickness Tc may fulfil the following condition: Tc<2 mm and the internal region thickness Ti may fulfil the following condition: Ti<Tc.

The center region thickness Tc may fulfil the following condition: 2 mm≤Tc and the internal region thickness Ti may fulfil the following condition: Ti=Tc.

An insert wedge angle awi, formed between the first converging insert abutment surface and the second converging insert abutment surface, and an insert seat angle asi, formed between the first converging holder abutment surface and the second converging holder abutment surface, may fulfil the following condition: 25°≤awi, asi≤80°.

A first holder abutment angle ah1, formed between a first holder normal, normal to the first converging holder abutment surface, and the longitudinal axis, may fulfil the following condition: −10°≤ah1≤10°.

A second holder abutment angle ah2, formed between a second holder normal, normal to the second converging holder abutment surface, and the longitudinal axis, may fulfil the following condition: 130°≤ah2≤150°.

The two-way indexable V-shaped cutting insert secured in the insert seat may be delimited in the forward direction by an active cutting edge, the active cutting edge being the forwardmost of the first and second cutting edges.

The cutting tool may be delimited in the forward direction by the active cutting edge.

The two-way indexable V-shaped cutting insert may further comprise a through bore opening out to the first and second insert abutment sub-surfaces. The insert seat of the tool holder may further comprise a holder bore opening out to the main holder abutment surface. The first and second converging insert abutment surfaces may each abut one of the first and second converging holder abutment surfaces. One of the first and second insert abutment sub-surfaces may abut the main holder abutment surface. The fastening member may pass through the through bore of the two-way indexable V-shaped cutting insert, engage the holder bore and releasably secure the two-way indexable V-shaped cutting insert to the tool holder.

### BRIEF DESCRIPTION OF THE FIGURES

For a better understanding of the present application and to show how the same may be carried out in practice, reference will now be made to the accompanying drawings, in which:

FIG. 1 is a perspective view of a cutting tool in accordance with an aspect of the present application;

FIG. 2 is an exploded view of the cutting tool shown in FIG. 1;

FIG. 3 is a perspective view of the two-way indexable V-shaped cutting insert shown in FIG. 1;

FIG. 4 is a flipped side view of the two-way indexable V-shaped cutting insert shown in FIG. 3;

FIG. 5 is an abutment side view of the two-way indexable V-shaped cutting insert shown in FIG. 4;

FIG. 6 is a first side view of the tool holder shown in FIG. 1;

FIG. 7 is a front view of the tool holder shown in FIG. 6;

FIG. 8 is a first side view of the cutting tool shown in FIG. 1;

FIG. 9 is a perspective view of a two-way indexable V-shaped cutting insert in accordance with another aspect of the present application;

FIG. 10 is a flipped side view of the two-way indexable V-shaped cutting insert shown in FIG. 9;

FIG. 11 is an abutment side view of the two-way indexable V-shaped cutting insert shown in FIG. 9;

FIG. 12 is a perspective view of a cutting tool in accordance with a second aspect of the present application;

FIG. 13 is a first side view of the cutting tool shown in FIG. 12; and

FIG. 14 is a first side view of the tool holder shown in FIG. 12.

It will be appreciated that for simplicity and clarity of illustration, elements shown in the figures have not necessarily been drawn to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF THE INVENTION

In the following description, various aspects of the subject matter of the present application will be described. For purposes of explanation, specific configurations and details are set forth in sufficient detail to provide a thorough understanding of the subject matter of the present application. However, it will also be apparent to one skilled in the ar1 that the subject matter of the present application can be practiced without the specific configurations and details presented herein.

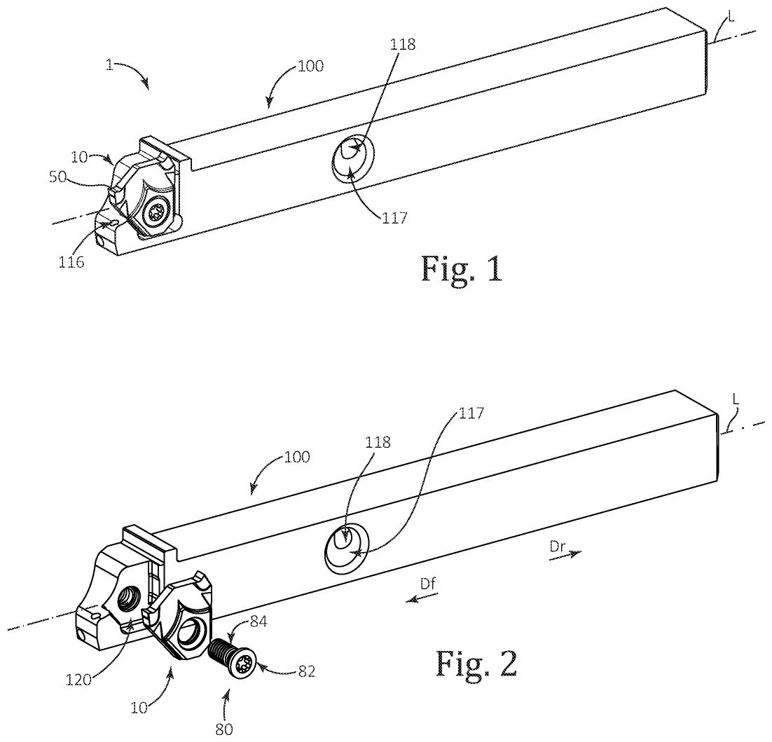

Attention is first drawn to FIGS. 1 and 2, showing a cutting tool 1 according to the present application. The cutting tool 1 includes a two-way indexable V-shaped cutting insert 10, a fastening member 80 and a tool holder 100. The two-way indexable V-shaped cutting insert 10 is releasably secured to the tool holder 100 via the fastening member 80. The two-way indexable V-shaped cutting insert 10 is typically made of harder material than the tool holder 100, such as cemented carbide, for example.

The two-way indexable V-shaped cutting insert 10 is preferably but optionally plate-shaped. The two-way indexable V-shaped cutting insert 10 may be used, for example, in grooving and parting operations. Specifically, the cutting tool 1 may be a Swiss turning cutting tool used in Swiss machining operations. Swiss turning operations relate to complex and high precision cutting operations, frequently having small dimensions with a high density of cutting tools placed in a turret. Alternatively, the two-way indexable V-shaped cutting insert 10 may have a cutting edge geometry (i.e. a cutting edge having a straight/sloping/V-shaped/contoured shape) meant for turning or threading operations, for example.

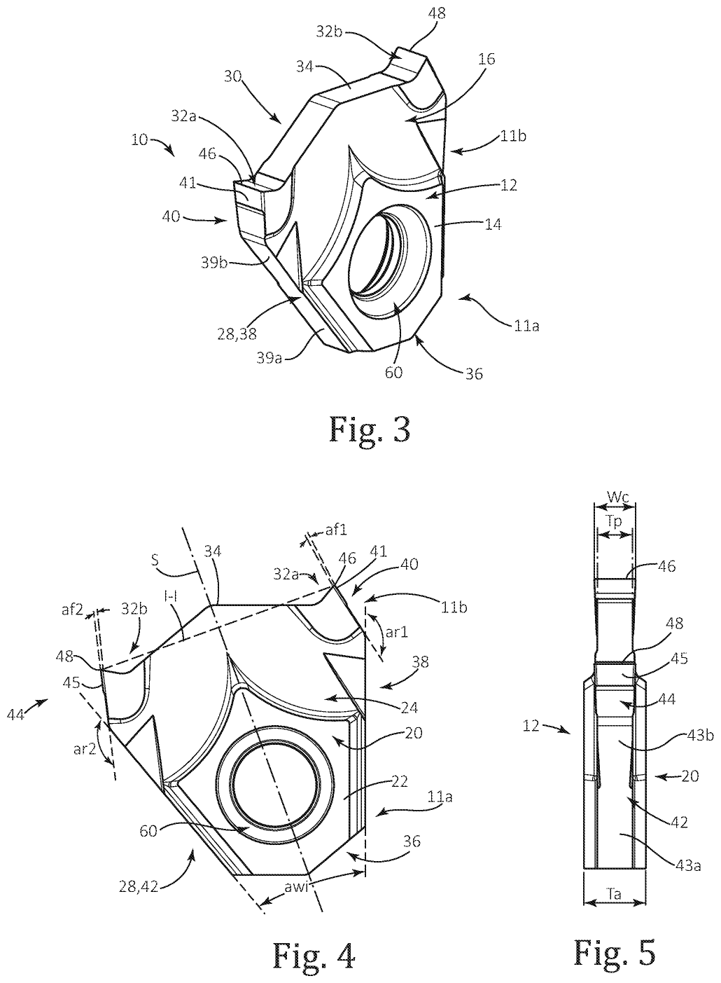

As seen in FIGS. 3 to 5, the two-way indexable V-shaped cutting insert 10 includes an insert abutment portion 11a, an insert cutting portion 11b, a first insert side surface 12, a second insert side surface 20 and a peripheral insert surface 28 connecting the first and second insert side surfaces 12, 20. In a side view, as shown in FIG. 4, the two-way indexable V-shaped cutting insert 10 includes a narrow end at the bottom of the V-shape and a wider end at the top of the V-shape. The insert abutment portion 11a is provided at the narrow end of the two-way indexable V-shaped cutting insert 10 and the insert cutting portion 11b is provided at the wider end of the two-way indexable V-shaped cutting insert 10. A symmetry plane S passes through the first and second insert side surfaces 12, 20 and bisects the two-way indexable V-shaped cutting insert 10.

The first and second insert side surfaces 12, 20 are located on opposing sides of the symmetry plane S. The first insert side surface 12 includes a first insert abutment sub-surface 14 located in the insert abutment portion 11a and a first cutting sub-surface 16 located in the insert cutting portion 11b. The second insert side surface 20 includes a second insert abutment sub-surface 22 located in the insert abutment portion 11a and a second cutting sub-surface 24 located in the insert cutting portion 11b. One of the first and second insert abutment sub-surfaces 14, 22 abuts the tool holder 100 when the two-way indexable V-shaped cutting insert 10 is secured thereto, as will be explained below. Preferably but optionally, the first and second insert side surfaces 12, 20 are identical to one another.

The insert cutting portion 11b includes a first cutting edge 46 and a second cutting edge 48. The first and second cutting edges 46, 48 are located on opposing sides of the symmetry plane S and are oriented transversely (i.e. non-parallel) to the first and second insert side surfaces 12, 20.

Preferably but optionally, the insert abutment portion 11a is thicker than the insert cutting portion 11b. To clarify, an abutment portion thickness Ta is defined as the minimal distance from the first insert abutment sub-surface 14 to the second insert abutment sub-surface 22. A cutting portion thickness Tp is defined as the minimal distance from the first cutting sub-surface 16 to the second cutting sub-surface 24. The abutment portion thickness Ta and the cutting portion thickness Tp may fulfil the following condition: Ta>Tp. Specifically, the abutment portion thickness Ta and the cutting portion thickness Tp may fulfill the following condition: 1.5*Tp≤Ta. An increase in the thickness of the first and second insert abutment sub-surfaces 14, 22 (i.e. the abutment portion thickness Ta) relative to the thickness of the first and second cutting sub-surfaces 16, 24 (i.e. the cutting portion thickness Tp) may reinforce the two-way indexable V-shaped cutting insert 10 and may, for example, allow for less vibrations during machining operations.

As shown in FIG. 5, a cutting width We of the first and second cutting edges 46, 48 is defined in an abutment side view of the two-way indexable V-shaped cutting insert 10 as the width of the first and second cutting edge 46, 48 in a direction from one of the first and second insert side surfaces 12, 20 to the other surface of the first and second insert side surfaces 12, 20. In some embodiments the cutting width Wc, the cutting portion thickness Tp and the abutment portion thickness Ta fulfil the following condition: Ta>Wc>Tp.

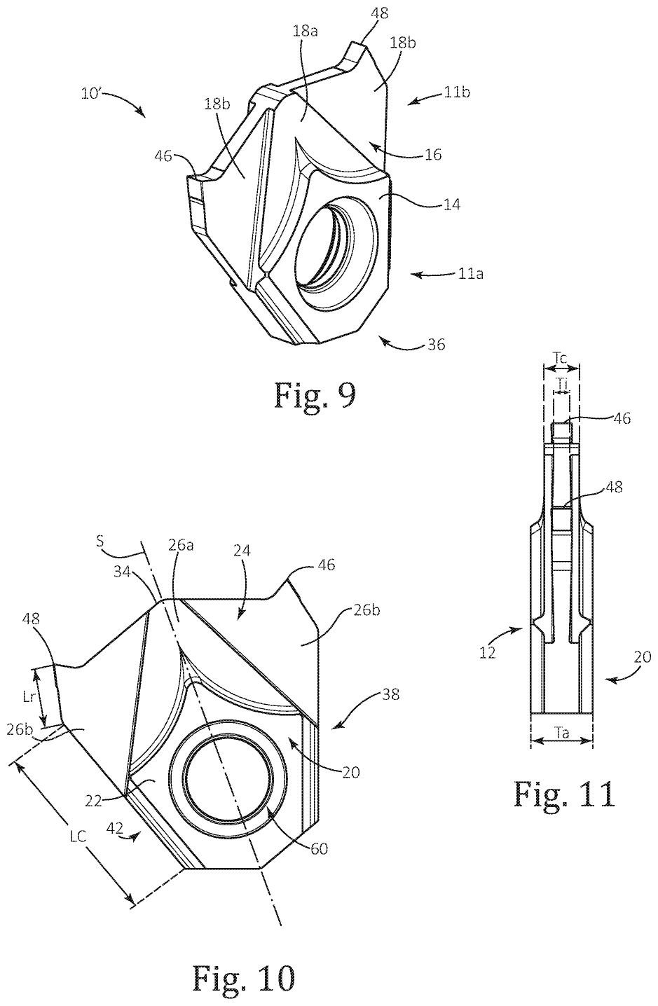

As seen in FIGS. 9 to 11, another two-way indexable V-shaped cutting insert 10′ according to the subject matter of the current application is shown. To simplify, features shared by both of the two-way indexable V-shaped cutting inserts 10, 10′ have the same numerals. The first cutting sub-surface 16 of the two-way indexable V-shaped cutting insert 10′ includes a first center region 18a and a first internal region 18b. Similarly, the second cutting sub-surface 24 includes a second center region 26a and a second internal region 26b. The first and second internal regions 18b, 26b are located closer to the first and second cutting edges 46, 48 than the first and second center regions 18a, 26a. In some embodiments, the first and second internal regions 18b, 26b may each be divided, respectively, by the first and second center regions 18a, 26a into separate regions.

The first and second internal regions 18b, 26b are narrower than the first and second cutting edges 46, 48 (i.e. the cutting width We is greater than the cutting portion thickness Tp: Wc>Tp). Thus, the first and second internal regions 18b, 26b are capable of entering, during parting and grooving operations, the groove being machined in the workpiece (not shown). The first and second center regions 18a, 26a may be capable of entering the groove. Differently worded, while the first and second internal regions 18b, 26b are always capable of fitting into the grooves machined by their respective cutting edge of the first and second cutting edges 46, 48, there are cases in which the first and second center regions 18a, 26a will be incapable of fitting into the grooves being machined. Differences in thickness such as described above may, for example, reinforce the two-way indexable V-shaped cutting insert 10′, allowing for less vibrations during machining operations.

Accordingly, in some embodiments, a center region thickness Tc, defined as the minimal distance from the first center region 18a to the second center region 26a, and an internal region thickness Ti, defined as the minimal distance from the first internal region 18b to the second internal region 26b, may fulfil the following condition: Ti≤Tc.

In some embodiments, the center region thickness Tc fulfils the following condition: Tc<2 mm and the internal region thickness Ti fulfils the following condition: Ti<Tc. In such embodiments, the first and second center regions 18a, 26a are incapable of fitting into the grooves being machined, which the first and second internal regions 18b, 26b are able to fit into. As such, the depth of cut of the two-way indexable V-shaped cutting insert 10 is limited to only the area of the first and second internal regions 18b, 26b. It may be found desirable, for very thin two-way indexable V-shaped cutting inserts 10′ to have such a difference in thickness in the insert cutting portion 11b, as it may stabilize and reinforce them against cutting forces.

In some embodiments, the center region thickness Tc, the internal region thickness Ti and the cutting width We fulfil the following condition: Tc>We>Ti. Such conditions allows to maximize the rigidity of the two-way indexable V-shaped cutting insert 10, 10′ while still allowing parts of the two-way indexable V-shaped cutting insert 10, 10′ to fit within a groove being machined by said two-way indexable V-shaped cutting insert 10, 10′.

In some embodiments, for example as seen in FIGS. 3 to 5, the center region thickness Tc fulfils the following condition: 2 mm≤Tc, and the internal region thickness Ti fulfils the following condition: Ti=Tc. In such embodiments, the first and second center regions 18a, 26a are capable of fitting into the grooves being machined. Accordingly, the depth of cut of the two-way indexable V-shaped cutting insert 10 is increased (compared to embodiments where Tc>Ti) to the whole area of the first and second cutting sub-surfaces 16, 24. For sufficiently thick two-way indexable V-shaped cutting inserts 10 it may be desirable to increase the depth of cut possible during machining operations rather than to reinforce them against the cutting forces (which is done in embodiments where Tc>Ti).

If the two-way indexable V-shaped cutting insert 10 is too thin (specifically the thickness between the first and second cutting sub-surfaces 16, 24) the performance of the cutting tool 1 will deteriorate. Thus, when a cutting operation calls for a two-way indexable V-shaped cutting insert 10 being thin enough, the depth of cut of the two-way indexable V-shaped cutting insert 10 may be reduced to allow for better quality performance (for example, less chatter or better surface quality). Likewise, if the cutting operation allows for a thick enough two-way indexable V-shaped cutting insert 10, the depth of cut does not need to be reduced.

The first and second center regions 18a, 26a are located opposite one another. Preferably but optionally the first and second center regions 18a, 26a may exhibit mirror symmetry relative to one another about the symmetry plane S. Similarly, the first center region 18a may be identical to the second center region 26a. Further, the first and second center regions 18a, 26a may be parallel to one another.

Likewise, the first and second internal regions 18b, 26b oppose one another and, preferably but optionally, may exhibit mirror symmetry relative to one another about the symmetry plane S. The first internal region 18b may be identical to the second internal region 26b. The first and second internal regions 18b, 26b may further be parallel to one another. It will be noted that the first and second internal regions 18b, 26b may be discontinuous. For example, the first and second center regions 18a, 26a may, respectively, divide the first and second internal regions 18b, 26b.

With further reference to FIGS. 3-5, the peripheral insert surface 28 includes a front insert surface 30, a back insert surface 36, a first converging insert abutment surface 38, a second converging insert abutment surface 42, a first relief surface 40 and a second relief surface 44. The front and back insert surfaces 30, 36 oppose one another and connect the first and second insert side surfaces 12, 20. The front insert surface 30 includes first and second rake surfaces 32a, 32b.

The first and second converging insert abutment surfaces 38,42 are located on opposite sides of the symmetry plane S. Further, the first and second converging insert abutment surfaces 38, 42 are located between the front and back insert surfaces 30, 36 and converge towards one another in a direction away from the front insert surface 30 and towards the back insert surface 36.

Providing the first and second rake surfaces 32a, 32b in the front insert surface 30 allows seating the two-way indexable V-shaped cutting insert 10 in desirable positioning, relative to the tool holder 100. During machining operations, cutting forces arising from machining a rotating workpiece are thus directed in a direction from the front insert surface 30 to one of the back insert surface 36 and the first and second converging insert abutment surfaces 38, 42. This may be very advantageous in Y-axis machining (discussed below). This may further allow for machining workpieces with large diameters.

In some embodiments, the first and second converging insert abutment surfaces 38, 42 may intersect the back insert surface 36. Preferably but optionally, the first and second converging insert abutment surfaces 38, 42 may further intersect the first and second relief surfaces 40, 44, respectively.

To specify, a distance from the first converging insert abutment surface 38 to the second converging insert abutment surface 42 when measured adjacent to the front insert surface 30 is greater than said distance when measured adjacent the back insert surface 36. The first and second converging insert abutment surfaces 38, 42 connect the first and second insert side surfaces 12, 20. Preferably but optionally, the first and second converging insert abutment surfaces 38, 42 are planar.

The first converging insert abutment surface 38 includes a first converging abutment sub-surface 39a and a first converging cutting sub-surface 39b. The second converging insert abutment surface 42 includes a second converging abutment sub-surface 43a and a second converging cutting sub-surface 43b. The first and second converging abutment sub-surfaces 39a, 43a are located adjacent to the first and second insert abutment sub-surfaces 14, 22. The first and second converging cutting sub-surfaces 39b, 43b are located adjacent to the first and second cutting sub-surfaces 16, 24.

The first and second converging abutment sub-surfaces 39a, 43a abut the tool holder 100 when the cutting tool 1 is assembled. The first and second converging cutting sub-surfaces 39b, 43b do not necessarily abut the tool holder 100 when the cutting tool 1 is assembled. Instead, the first and second converging cutting sub-surfaces 39b, 43b are capable of being located within a groove being machined by the cutting tool 1 while the first and second converging abutment sub-surfaces 39a, 43a, in some embodiments, are not able to fit within such a groove.

Preferably but optionally, one of the first and second converging cutting sub-surfaces 39b, 43b abuts the tool holder 100 when the cutting tool 1 is assembled, as will be discussed below.

The first relief surface 40 connects the first rake surface 32a and the first converging insert abutment surface 38. The second relief surface 44 connects the second rake surface 32b and the second converging insert abutment surface 42. The first and second relief surfaces 40, 44 do not abut the tool holder 100 when the cutting tool 1 is assembled. Preferably but optionally, the first and second relief surfaces 40, 44 are at least partially planar.

In some embodiments, the first and second relief surfaces 40, 44 may include, respectively, first and second relief sub-surfaces 41, 45. The first relief sub-surface 41 extends from the first cutting edge 46 and the second relief sub-surface 45 extends from the second cutting edge 48. The first and second relief sub-surfaces 41, 45, are preferably but optionally at least partially planar.

A first relief sub-angle af1 is formed between the first relief surface 40 and the first relief sub-surface 41. A second relief sub-angle af2 is formed between the second relief surface 44 and the second relief sub-surface 45. Preferably but optionally, the first and second relief sub-angles af1, af2 fulfill the following condition: af1=af2. Specifically, the first and second relief sub-angles af1, af2 may fulfill the following condition: 4°≤af1, af2≤12°. More specifically, the first and second relief sub-angles af1, af2 may fulfill the following condition: 5°≤af1, af2≤8°.

A relief surface length Lr is defined, in a side view (only shown in FIG. 10 but equally applicable in the embodiment of FIG. 4), from one of the first and second cutting edges 46, 48 to the closest area of its respective surface of the first and second converging insert abutment surfaces 38, 42 (i.e., spanning the length of one of the first and second relief surfaces 40, 44). A converging insert surface length Lc is defined, in a side view, from the back insert surface 36 to the closest area of one of the first and second relief surfaces 40, 44 (i.e., spanning the length of one of the first and second converging insert abutment surfaces 38, 42). Preferably but optionally, the relief surface length Lr and the converging insert surface length Lc fulfil the following condition: Lr<Lc. Specifically, the relief surface length Lr and the converging insert surface length Lc may fulfil the following condition: 3*Lr≤Lc.

The two-way indexable V-shaped cutting insert 10, 10′ includes exactly two cutting edges constituted by the first and second cutting edges 46, 48. The first cutting edge 46 is located at an intersection of the first rake surface 32a and the first relief surface 40. The second cutting edge 48 is located at the intersection of the second rake surface 32b and the second relief surface 44.

During turning operations, one of the first and second cutting edges 46, 48 are active and cut away at a workpiece (not shown) being machined. The cutting edge of the first and second cutting edges 46, 48 which is active during machining will interchangeably be referred to as an active cutting edge 50.

In some embodiments, the first and second relief surfaces 40, 44 extend transverse to (i.e., non-parallel), respectively, the first and second converging insert abutment surfaces 38, 42. Differently worded, a first insert relief angle ar1 is formed internally between the first relief surface 40 and the first converging insert abutment surface 38, and a second insert relief angle ar2 is formed internally between the second relief surface 44 and the second converging insert abutment surface 42.

In some embodiments, the first and second insert relief angles ar1, ar2 may fulfil the following condition: 90°≤ar1, ar2≤175°. The first and second insert relief angles ar1, ar2 may further fulfil the following condition: ar1=ar2. Preferably, first and second insert relief angles ar1, ar2 may fulfil the following condition: 120°≤ar1, ar2≤165°. More preferably, the first and second insert relief angles ar1, ar2 may fulfil the following condition: 135°≤ar1, ar2≤155°. The first and second insert relief angles ar1, ar2 have an impact on the manner the insert is positioned relative to the tool holder 100. To facilitate cutting, cutting inserts have a relief (i.e. have a distance/separation) between the workpiece being machined and the cutting inserts (the angle between the direction of the cutting forces during machining operations and the adjacent relief surface is usually no greater than 10°). Thus, the two-way indexable V-shaped cutting insert 10, 10′ is positioned to ensure that a relief is maintained between the workpiece and the relief surface of the first and second relief surfaces 40, 44 adjacent the active cutting edge 50. As such, for differing values of the first and second insert relief angles ar1, ar2, the two-way indexable V-shaped cutting insert 10, 10′ must be differently situated in the tool holder 100 to allow relief between the relief surface and the workpiece. The above conditions for the first and second insert relief angles ar1, ar2 thus define the desirable positioning of the two-way indexable V-shaped cutting insert 10, 10′ relative to the tool holder 100.

In some embodiments, the front insert surface 30 may further include a chip deflection protrusion 34. The chip deflection protrusion 34 is located between the first and second rake surfaces 32a, 32b. The chip deflection protrusion 34 is also located farther from the back insert surface 36 than at least a portion of the first and second rake surfaces 32a, 32b exemplified by a deflection line I-I (shown in FIG. 4) which intersects the chip deflection protrusion 34 and connects two portions of the first and second rake surfaces 32a, 32b.

Preferably but optionally, the chip deflection protrusion 34 is intersected by the deflection line I-I when connecting the portions of the first and second rake surfaces 32a, 32b adjacent to the first and second cutting edges 46, 48, respectively. That is to say, the chip deflection protrusion 34 is, preferably but optionally, located farthest from the back insert surface 36.

Having the chip deflection protrusion 34 extending away from the back insert surface 36 and located between the first and second rake surfaces 32a, 32b may ensure that, during machining operations, chips cut away from the workpiece being machined by the first cutting edge 46 (when the first cutting edge 46 serves as the active cutting edge 50) would not impact the second cutting edge 48.

The cutting forces arising from having the cutting tool 1 machining the workpiece are generally directed in a direction from the front insert surface 30 to the back insert surface 36 and the resulting chips are guided along the front insert surface 30, specifically along one of the first and second rake surfaces 32a, 32b. The first and second relief surfaces 40, 44 are angled to allow the necessary relief from the workpiece during the operation. This may allow for machining workpieces with large diameters and a directionality of cutting forces during machining operations further securing the two-way indexable V-shaped cutting insert 10, 10′ in the tool holder 100.

This may also allow the two-way indexable V-shaped cutting insert 10, 10′, during machining operations, to be oriented in the tool holder 100 so as to be delimited in a longitudinal direction of the cutting tool 1 by the active cutting edge 50. In Swiss machining operations it may be desirable to have the active cutting edge 50 delimiting the two-way indexable V-shaped cutting insert 10, 10′ as specified. Further advantages may be, for example, the cutting forces wedging the two-way indexable V-shaped cutting insert 10, 10′ into the tool holder 100, which may result in better stability of the cutting tool 1 during cutting operations.

The symmetry plane S may bisect an insert wedge angle awi, formed between the first converging insert abutment surface 38 and the second converging insert abutment surface 42. The insert wedge angle awi is internal to the two-way indexable V-shaped cutting insert 10, 10′. More specifically, the symmetry plane S may be perpendicular to the first and second insert side surfaces 12, 20.

In some embodiments, the first cutting edge 46 exhibits mirror symmetry relative to the second cutting edge 48 about the symmetry plane S. Further, the first converging insert abutment surface 38 may exhibit mirror symmetry relative to the second converging insert abutment surface 42 about the symmetry plane S. Additionally, the two-way indexable V-shaped cutting insert 10, 10′ may exhibit mirror symmetry about the symmetry plane S.

In some embodiments, the insert wedge angle awi may fulfil the following condition: 25°≤awi≤80°. Specifically, the insert wedge angle awi may fulfil the following condition: 30°≤awi≤70°. More specifically, the insert wedge angle awi may fulfill the following condition: 35°≤awi≤55°. Having the insert wedge angle awi too great may cause strength of the connection between the two-way indexable V-shaped cutting insert 10, 10′ and the tool holder 100 to deteriorate which may result in more vibrations during machining operations, for example. Having the insert wedge angle awi too small may cause the two-way indexable V-shaped cutting insert 10, 10′ to change its cutting edge height relative to the workpiece due to deflection in the tool holder 100, for example.

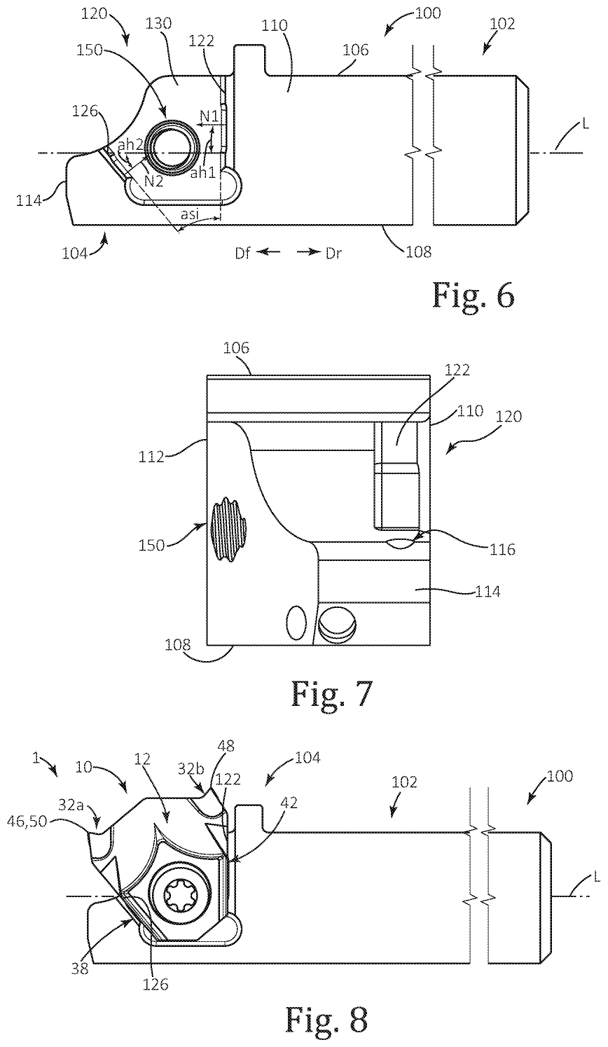

Referring now to FIGS. 6 to 8, the tool holder 100 has a longitudinal axis L. The longitudinal axis L defines opposing forward and rearward directions Df, Dr (i.e. directions parallel to the longitudinal axis L). The tool holder 100 includes a shank portion 102, a holder cutting portion 104, a top holder surface 106, a bottom holder surface 108, a front holder surface 110, a back holder surface 112 and a forward holder surface 114.

The shank portion 102 is secured in a turret during machining operations. The holder cutting portion 104 is located in the forward direction Df from the shank portion 102 and includes an insert seat 120 meant for securing the two-way indexable V-shaped cutting insert 10, 10′ thereto. The top, bottom, front, back and forward holder surfaces 106, 108, 110, 112, 114 may span both the shank portion 102 and the holder cutting portion 104.

The top and bottom holder surfaces 106, 108 oppose one another about (i.e. on opposite sides of) the longitudinal axis L. The top and bottom holder surfaces 106, 108 may extend along (i.e. elongated in a direction of) the longitudinal axis L. The front and back holder surfaces 110, 112 oppose one another about the longitudinal axis L and connect the top and bottom holder surfaces 106, 108. The front and back holder surfaces 110, 112 may also extend along the longitudinal axis L. The forward holder surface 114 is located between the top, bottom, front and back holder surfaces 106, 108, 110, 112 and delimits the tool holder 100 in the forward direction Df. Preferably but optionally, the forward holder surface 114 also connects the top, bottom, front and back holder surfaces 106, 108, 110, 112.

In some embodiments, the top, bottom, front back and forward holder surfaces 106, 108, 110, 112, 114 may each be planar surfaces. The top and bottom holder surfaces 106, 108 may be parallel to one another. the front and back holder surfaces 110, 112 may be parallel to one another and perpendicular to the top and bottom holder surfaces 106, 108. The forward holder surface 114 may be perpendicular to the top, bottom, front and back holder surfaces 106, 108, 110, 112.

The insert seat 120 opens out to the front and forward holder surfaces 110, 114. Preferably but optionally the insert seat further opens out to the top holder surface 106. The insert seat 120 includes a first converging holder abutment surface 122, a second converging holder abutment surface 126 and a main holder abutment surface 130. The main holder abutment surface 130 connects the first and second converging holder abutment surfaces 122, 126. Preferably but optionally, the main holder abutment surface 130 extends parallel to the longitudinal axis L. The main holder abutment surface 130 may also extend parallel to the front and back holder surfaces 110, 112.

In some embodiments, the first converging holder abutment surface 122 may be forwardly facing (i.e. facing in the forward direction Df). Likewise, the second converging holder abutment surface 126 may be rearwardly facing (i.e. facing the rearward direction Dr) and located forwardly of the first converging holder abutment surface 122. In such orientation, the two-way indexable V-shaped cutting insert 10, 10′ seated in the tool holder 100 are coupled in a manner resulting in cutting forces arising during machining operations by the cutting tool 1 being directed transverse to the longitudinal axis L. This is known in the field as X-axis cutting operations.

In cutting operations referred to as “Y-Axis” cutting operations, cutting forces arising from the cutting operations are directed along the length of the cutting tool (i.e. along its longitudinal axis).

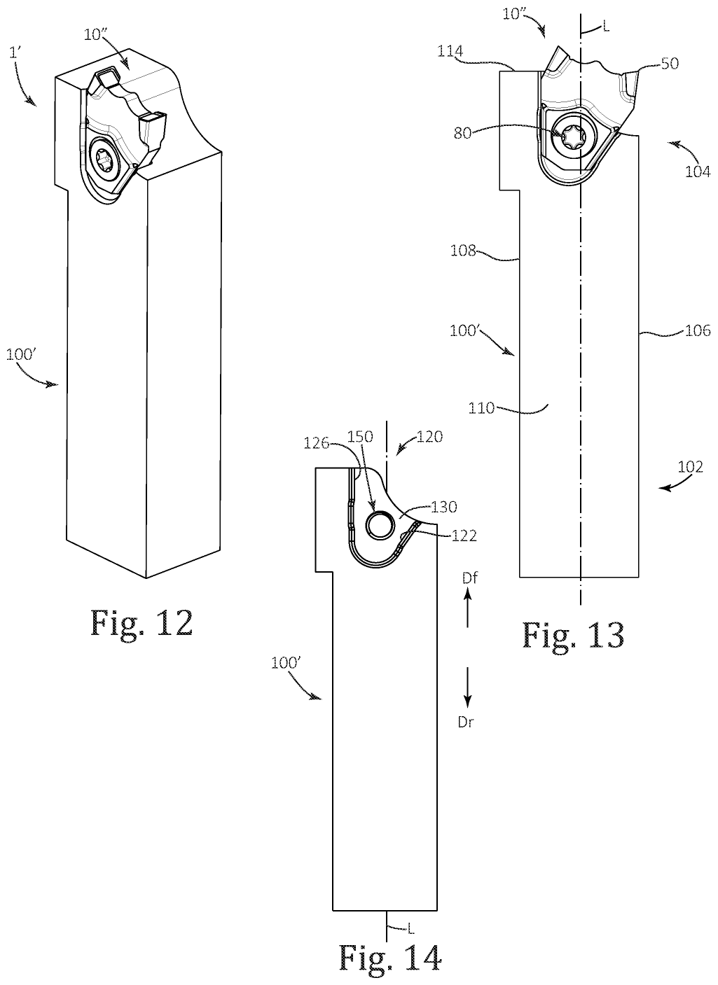

In some embodiments, such as shown in FIGS. 12 to 14, a cutting tool 1′ may be used in Y-axis operations. The cutting tool 1′ includes a two-way indexable V-shaped cutting insert 10″ and a tool holder 100′. The two-way indexable V-shaped cutting insert 10″ and the tool holder 100′ are coupled in a manner resulting in cutting forces arising during machining operations being directed along the longitudinal axis L (i.e. Y-axis cutting operations).

The two-way indexable V-shaped cutting insert 10″ may be identical to the two-way indexable V-shaped cutting insert 10, 10′ described above. The tool holder 100′ is made to facilitate Y-axis cutting operations. Specifically, the first converging holder abutment surface 122 may be located closer to the top holder surface 106 than the second converging holder abutment surface 126. Having the first and second converging holder abutment surfaces 122, 126 oriented as such will allow the positioning of the two way indexable V-shaped cutting insert 10″ to be better equipped for Y-axis machining. The first converging holder abutment surface 122 may further oppose the second converging holder abutment surface 126 about the longitudinal axis L.

In some embodiments, the two-way indexable V-shaped cutting insert 10, 10′, 10″ may further include a through bore 60 opening out to the first and second insert side surfaces 12, 20. Specifically, the through bore 60 opens out to the first and second insert abutment sub-surfaces 14, 22. The insert seat 120 may further include a holder bore 150 opening out to the main holder abutment surface 130. The fastening member 80 may be a screw 80 having a screw head 82 and a threaded portion 84. Different fastening members are also possible, for example clamp type fastening members (not shown) and bayonet coupling type fastening members (not shown).

When fastening the two-way indexable V-shaped cutting insert 10, 10′, 10″ to the tool holder 100, 100′, the two-way indexable V-shaped cutting insert 10, 10′, 10″ is placed in the insert seat 120. One of the first and second insert abutment sub-surfaces 14, 22 abuts against the main holder abutment surface 130. Each of the first and second converging abutment sub-surfaces 39a, 43a abuts a different one of the first and second converging holder abutment surfaces 122, 126. Preferably but optionally, one of the first and second cutting sub-surfaces 39b, 43b, specifically the one furthest from the active cutting edge 50, abuts the first converging holder abutment surface 122 as well. This may facilitate better support for the two-way indexable V-shaped cutting insert 10, 10′, 10″ secured to the tool holder 100, 100′.

The fastening member 80 may pass through the through bore 60 of the two-way indexable V-shaped cutting insert 10, 10′, 10″, engage the holder bore 150 and releasably secure the two-way indexable V-shaped cutting insert 10, 10′, 10″ to the tool holder. Specifically, in embodiments where the fastening member 80 is a screw, the threaded portion 84 passes through the through bore 60 and engages the holder bore 150. The screw head 82 abuts against the two-way indexable V-shaped cutting insert 10, 10′, 10″ and secures it to the tool holder 100, 100′.

In some embodiments, when the two-way indexable V-shaped cutting insert 10, 10′, 10″ is fastened to the insert seat 120 of the tool holder 100, 100′, it is preferable but optional that the two-way indexable V-shaped cutting insert 10, 10′, 10″ is delimited in the forward direction Df by the active cutting edge 50. It is preferable but optional that the cutting tool 1 is delimited in the forward direction by the active cutting edge 50. In Swiss machining operations, it may be desirable that there are no projections in the forward direction from the active cutting edge 50.

In some embodiments, an insert seat angle asi, which is defined external to the tool holder 100, 100′ from the first converging holder abutment surface 122 to the second converging holder abutment surface 126, may fulfil the following condition: asi=awi.

The insert seat angle asi may fulfil the following condition: 25°≤asi≤80°. The insert seat angle asi may further fulfil the following condition: 30°≤asi≤70°. Specifically, the insert seat angle asi may fulfill the following condition: 35°≤asi≤55°.

In some embodiments, a first holder abutment angle ah1, which is formed between a first holder normal N1 which is normal to the first converging holder abutment surface 122 (i.e. perpendicular to), and the longitudinal axis L, may fulfil the following condition: −10°≤ah1≤10°.

In some embodiments, a second holder abutment angle ah2, which is formed between a second holder normal N2 which is normal to the second converging holder abutment surface 126, and the longitudinal axis L, may fulfil the following condition: 30°≤ah2≤50°. For higher values of the second holder abutment angle ah2, the cutting forces arising during X-axis machining operations may cause excessive strain on the second converging holder abutment surface 126 which supports the two-way indexable V-shaped cutting insert 10, 10′, 10″ directly against the cutting forces. Alternatively, for lower values of the second holder abutment angle ah2, the cutting forces arising during X-axis machining operations may force apart the first and second converging holder abutment surfaces 122, 126. Note that the first and second holder abutment angles ah1, ah2, as well as the insert seat angle asi correlate to one another. Said angles ensure that the insert seat 120 is rigid. Further, said angles ensure the rigidity of the second converging holder abutment surface 126.

In some embodiments, the tool holder 100, 100′ includes a coolant outlet 116 in fluid connection with a coolant inlet 117. The coolant outlet 116 and coolant inlet 117 may be connected by a coolant channel 118. The coolant outlet 116 may be positioned directly below the active cutting edge 50 (i.e. a line perpendicular to the longitudinal axis L passes through both the active cutting edge 50 and the coolant outlet 116). This is possible due to the orientation of the two-way indexable V-shaped cutting insert 10, 10′, 10″ in the tool holder 100, 100′—having the active cutting edge 50 delimit the two-way indexable V-shaped cutting insert 10, 10′, 10″ in the forward direction Df allows direct access to a coolant/lubricant from below.

Although the subject matter of the present application has been described to a certain degree of particularity, it should be understood that various alterations and modifications could be made without departing from the spirit or scope of the invention as hereinafter claimed.

What is claimed is:

1. A two-way indexable V-shaped cutting insert (10, 10′, 10″) comprising:
a first insert side surface (12) and a second insert side surface (20) located opposite the first insert side surface (12); and
a peripheral insert surface (28) connecting the first and second insert side surfaces (12, 20);
the peripheral insert surface (28) comprising:
a front insert surface (30) located in an insert cutting portion (11b);
a back insert surface (36) located opposite the front insert surface (30) and located in an insert abutment portion (11a), the insert abutment portion (11a) being adjacent to the insert cutting portion (11b); and
first and second converging insert abutment surfaces (38, 42) converging towards one another in a direction away from the front insert surface (30) and towards the back insert surface (36);
wherein:
the front insert surface (30) comprises first and second rake surfaces (32a, 32b); and
the peripheral insert surface (28) further comprises:
a first relief surface (40) connecting the first rake surface (32a) and the first converging insert abutment surface (38);
a second relief surface (44) connecting the second rake surface (32b) and the second converging insert abutment surface (42); and
a first cutting edge (46) and a second cutting edge (48), the first cutting edge (46) located at the intersection of the first rake surface (32a) and the first relief surface (40), the second cutting edge (48) located at the intersection of the second rake surface (32b) and the second relief surface (44).

2. The two-way indexable V-shaped cutting insert (10, 10′, 10″) according to claim 1, wherein:
a first relief angle (ar1), formed between the first relief surface (40) and the first converging insert abutment surface (38), and a second relief angle (ar2), formed between the second relief surface (44) and the second converging insert abutment surface (42), fulfil the following condition: 90°<ar1, ar2<175°.

3. The two-way indexable V-shaped cutting insert (10, 10′, 10″) according to claim 1, wherein:
the two-way indexable V-shaped cutting insert (10, 10′, 10″) comprises exactly two cutting edges constituted by the first and second cutting edges (46, 48).

4. The two-way indexable V-shaped cutting insert (10, 10′, 10″) according to claim 1, wherein:
a symmetry plane (S) passes through the first and second insert side surfaces (12, 20) and bisects the two-way indexable V-shaped cutting insert (10, 10′, 10″); and
the first cutting edge (46) exhibits mirror symmetry relative to the second cutting edge (48) about the symmetry plane (S).

5. The two-way indexable V-shaped cutting insert (10, 10′, 10″) according to claim 4, wherein:
the first converging insert abutment surface (38) exhibits mirror symmetry relative to the second converging insert abutment surface (42) about the symmetry plane (S).

6. The two-way indexable V-shaped cutting insert (10, 10′, 10″) according to claim 5, wherein:
the two-way indexable V-shaped cutting insert (10, 10′, 10″) exhibits mirror symmetry about the symmetry plane (S).

7. The two-way indexable V-shaped cutting insert (10, 10′, 10″) according to claim 1, wherein:
an insert wedge angle awi, formed between the first converging insert abutment surface (38) and the second converging insert abutment surface (42), fulfils the following condition: 25°≤awi≤80°.

8. The two-way indexable V-shaped cutting insert (10, 10′, 10″) according to claim 1, wherein:
the first and second relief angles ar1, ar2 fulfil the following condition: 120°≤ar1, ar2≤165°.

9. The two-way indexable V-shaped cutting insert (10, 10′, 10″) according to claim 1, wherein:
the front insert surface (30) further comprises a chip deflection protrusion (34), the chip deflection protrusion (34) being located between the first and second rake surfaces (32a, 32b) and farther from the back insert surface (36) than at least a portion of the first and second rake surfaces (32a, 32b).

10. The two-way indexable V-shaped cutting insert (10, 10′, 10″) according to claim 1, wherein:
the first insert side surface (12) comprises a first insert abutment sub-surface (14) located in the insert abutment portion (11a) and a first cutting sub-surface (16) located in the insert cutting portion (11b);
the second insert side surface (20) comprises a second insert abutment sub-surface (22) located in the insert abutment portion (11a) and a second cutting sub-surface (24) located in the insert cutting portion (11b);
an abutment portion thickness Ta, defined from the first insert abutment sub-surface (14) to the second insert abutment sub-surface (22), and a cutting portion thickness Tp, defined from the first cutting sub-surface (16) to the second cutting sub-surface (24), fulfil the following condition: Ta>Tp.

11. The two-way indexable V-shaped cutting insert (10, 10′, 10″) according to claim 10, wherein:
the first cutting sub-surface (16) comprises a first center region (18a) and a first internal region (18b) located closer to the first and second cutting edges (46, 48) than the first center region (18a);
the second cutting sub-surface (24) comprises a second center region (26a) and a second internal region (26b) located closer to the first and second cutting edges (46, 48) than the second center region (26a); and
a center region thickness Tc, defined as the distance from the first center region (18a) to the second center region (26a), and an internal region thickness Ti, defined as the distance from the first internal region (18b) to the second internal region (26b), fulfil the following condition: Ti≤Tc.

12. The two-way indexable V-shaped cutting insert (10′) according to claim 11, wherein:
the center region thickness Tc fulfils the following condition: Tc<2 mm; and
the internal region thickness Ti fulfils the following condition: Ti<Tc.

13. The two-way indexable V-shaped cutting insert (10, 10″) according to claim 11, wherein:
the center region thickness Tc fulfils the following condition: 2 mm≤Tc; and
the internal region thickness Ti fulfils the following condition: Ti=Tc.

14. A cutting tool (1, 1′) comprising:
a two-way indexable V-shaped cutting insert (10, 10′, 10″) according to claim 1;
a fastening member (80); and
a tool holder (100, 100′) having a longitudinal axis (L) defining opposing forward and rearward directions (Df, Dr), the tool holder comprising:
a shank portion (102) and a holder cutting portion (104) located in the forward direction (Df) from the shank portion (102);
opposing top and bottom holder surfaces (106, 108) extending along, and on opposite sides of, the longitudinal axis (L);
opposing front and back holder surfaces (110, 112) extending along, and on opposite sides of, the longitudinal axis (L) and connecting the top and bottom holder surfaces (106, 108); and
a forward holder surface (114) located between the top, bottom, front and back surfaces (106, 108, 110, 112) and delimiting the tool holder (100, 100′) in the forward direction (Df);
the holder cutting portion (104) comprising:
an insert seat (120) opening out to the front and forward holder (110, 114) surfaces, the insert seat (120) comprising:
a first converging holder abutment surface (122);
a second converging holder abutment surface (126) located forwardly of the first converging holder abutment surface (122); and
a main holder abutment surface (130) connecting the first and second converging holder abutment surfaces (122, 126).

15. The cutting tool (1, 1′) according to claim 14, wherein:
an insert wedge angle awi, formed between the first converging insert abutment surface (38) and the second converging insert abutment surface (42), and an insert seat angle asi, formed between the first converging holder abutment surface (122) and the second converging holder abutment surface (126), fulfil the following condition: 25°≤awi, asi≤80°.

16. The cutting tool (1, 1′) according to claim 14, wherein:
a first holder abutment angle ah1, formed between a first holder normal (N1), normal to the first converging holder abutment surface (122), and the longitudinal axis (L), fulfils the following condition: −10°≤ah1≤10°.

17. The cutting tool (1, 1′) according to claim 14, wherein:
a second holder abutment angle ah2, formed between a second holder normal (N2), normal to the second converging holder abutment surface (126), and the longitudinal axis (L), fulfils the following condition: 130°≤ah2≤150°.

18. The cutting tool (1, 1′) according to claim 14, wherein:
the two-way indexable V-shaped cutting insert (10, 10′, 10″) secured in the insert seat (120) is delimited in the forward direction (Df) by an active cutting edge (50), the active cutting edge (50) being the forwardmost of the first and second cutting edges (46, 48).

19. The cutting tool (1, 1′) according to claim 18, wherein:
the cutting tool (1, 1′) is delimited in the forward direction (Df) by the active cutting edge (50).

20. The cutting tool (1) according to claim 14, wherein:
the two-way indexable V-shaped cutting insert (10, 10′, 10″) further comprises a through bore (60) opening out to the first and second insert abutment sub-surfaces (14, 22);
the insert seat (120) of the tool holder (100, 100′) further comprises a holder bore (150) opening out to the main holder abutment surface (130);
the first and second converging insert abutment surfaces (38, 42) each abuts one of the first and second converging holder abutment surfaces (122, 126);
one of the first and second insert abutment sub-surfaces (14,22) abuts the main holder abutment surface (130); and
the fastening member (80) passes through the through bore (60) of the two-way indexable V-shaped cutting insert (10, 10′, 10″), engages the holder bore (150) and releasably secures the two-way indexable V-shaped cutting insert (10, 10′, 10″) to the tool holder (100, 100′).
